(19) United States
(12) Patent Application Publication
(10) Pub. No.: US 2015/0115610 A1
(43) Pub. Date: Apr. 30, 2015

(54) INTEGRATED WIND TURBINE ACOUSTIC NOISE AND SHADOW-FLICKER DETECTION AND MITIGATION SYSTEM

(71) Applicants: Patrick Quinlan, Hadley, MA (US); William M. Stein, Amherst, MA (US); Brian Kuhn, Plymouth, MA (US)

(72) Inventors: Patrick Quinlan, Hadley, MA (US); William M. Stein, Amherst, MA (US); Brian Kuhn, Plymouth, MA (US)

(21) Appl. No.: 14/525,961

(22) Filed: Oct. 28, 2014

Related U.S. Application Data
(60) Provisional application No. 61/897,173, filed on Oct. 29, 2013.

(51) Int. Cl. F03D 7/04; F03D 9/00

(52) U.S. Cl. CPC F03D 7/042; F03D 9/002
USPC 290/44

(57) ABSTRACT

An integrated wind turbine acoustic-noise and shadow-flicker recognition system, comprising monitors located at nearby locations and base-units installed in each wind turbine, is described. The system comprehensively addresses neighbors' concerns with potential sound- and flicker-based nuisance emissions. Each monitor includes a computer processor; a microphone and light-monitor; a two-way communication system for interaction with the base-unit; and a set of indicator-lights. Each base-unit includes a computer processor; a two-way communication system for interacting with local monitors; plus a display, data-ports, and programming interfaces. Collectively, computer processors in the monitors and base-units jointly assess acoustic, optical, and turbine operating data to signal a mitigation event. The methods used to determine a mitigation event are based on a unique signature-recognition methodology that relies on analysis of data received at both the turbine and at the monitored location.

### CROSS-REFERENCE TO RELATED APPLICATIONS

This application claims priority to and the benefit of co-pending U.S. provisional patent application Ser. No. 61/897,173, filed Oct. 29, 2013, which application is incorporated herein by reference in its entirety.

### FIELD OF THE INVENTION

The invention relates to wind turbines in general and particularly to systems and methods for reducing unwanted audible and visual signals generated by the wind turbines.

### BACKGROUND OF THE INVENTION

Due to the operation of various mechanical and aerodynamic systems, wind turbines produce acoustic emissions in their vicinity. Whenever these acoustic emissions exceed a predetermined level or characteristic, it may be necessary to alter the performance of the wind turbine to avoid levels or characteristics that are prohibited or recognized as a nuisance.

Similarly, the same is true for shadows cast from a wind turbine. The rotating blades of a wind turbine may, on occasion, be aligned with the sun to create a cyclic shadow effect, called shadow-flicker, across a residence. When these shadow-flicker effects occur, it may also be important to signal the wind turbine to take actions to modify operations accordingly.

As the number of wind turbines installed near dwellings and other structures has risen, there have been a greater number of episodes where the wind turbines have been deemed a nuisance.

Shadow flicker-only systems have been proposed to measure light levels with respect to shadow-flicker, some of which are described in U.S. Pat. Nos. 7,619,321 and 8,310,075. In brief, these systems employ multiple sensors, deployed in the shadow path, for the comparison of light levels for the measurement of direct-to-indirect light levels. Other systems, including a system described in German Patent Application Publication DE 102005007471 A1, employ predictive devices installed at the wind turbine that—based on sun angles, insolation levels, and precision timing—avoid casting cyclic shadows on software-designated locations.

Acoustic monitoring-only systems have also been proposed, including the systems described in WO 2013023660 A1, for measuring sound at a wind turbine location. This application measures acoustic data at two locations, one near the wind turbine, and the other at a remote location, to recognize a wind turbine noise condition apart from ambient sources.

Finally, there have also been proposed separate systems for the independent acoustic and visual monitoring a wind turbine, such as those described in U.S. Pat. No. 8,041,540 and EP 2333329 A2 that compare data to stored baseline data to perceive deviations in operation that may trigger notification when the deviation exceeds a threshold. The design of this system is configured to provide additional operating data to the wind turbine operator, for monitoring of turbine performance and operating condition.

Known in the prior art is Wobben, U.S. Pat. No. 7,619,321, issued Nov. 17, 2009, (also published as WO2004/094818 on Nov. 4, 2004 and as U.S. Patent Application Publication No. 2006/0267347 A1 on Nov. 30, 2006) which is said to disclose the following: When planning and setting up wind power installations, the visual detractions to be expected on the part of the wind power installation on the environment play an increasingly important part in approval and acceptance. The shadow casting caused by the wind power installation on the adjoining properties is often perceived by the residents as being very troublesome. A wind power installation is provided by means of which shadow casting regulation is improved. That is achieved by a method of operating a wind power installation wherein a first light intensity is detected in a region of direct light irradiation and a second light intensity is detected in a shadowed region, and wherein the wind power installation is shut down if the difference between the first light intensity and the second light intensity is greater than a predetermined value.

Also known in the prior art is Sorensen et al., U.S. Pat. No. 8,310,075, issued Nov. 13, 2012, (also published as WO2009/030252 on Mar. 12, 2009 and as U.S. Patent Application Publication No. 20110204629 A1 on Aug. 25, 2011) which is said to disclose that a rotor of a wind turbine may cast an intermittent shadow onto an object in the vicinity of the turbine. A shadow-control system stops the wind turbine, based on a shadow-related shut-down condition. The condition is based on a result of a comparison between a direct-light intensity and an indirect-light intensity being beyond a direct-to-indirect light threshold. A set of light sensors measures the direct- and indirect-light intensities. A sensor measures the direct light intensity when irradiated by the sun, and the indirect-light intensity when not irradiated by the sun. The set of light sensors to provide the measured direct- and indirect-light intensities for the comparison consists of two sensors, an eastward-oriented sensor and a westward-oriented sensor.

Also known in the prior art is Thi Bui-Ngoc et al., German Patent Application Publication No. DE102005007471 A1, published Aug. 31, 2006, which is said to disclose the shadow switching off device for a wind power plant prevents local residents being disturbed by pulsating shadows. It makes use of a calculating unit to perform this function. A sensor is used to supply data for calculating the rotor setting. Another sensor is used to allow for the intensity of the shadow.

Also known in the prior art is Frank Ormel et al., U.S. Patent Application Publication No. 20140193257 A1, published Jul. 10, 2014 (and previously published as WO2013023660 A1 on Feb. 21, 2013), which is said to disclose an acoustic noise monitoring system for a wind turbine, comprising: a microphone for monitoring acoustic noise, the microphone adapted to be mounted to the exterior of a wind turbine nacelle; an input, the input adapted to receive operating conditions data from a wind turbine; a processor, the processor adapted to receive data from the microphone and the input; and storage memory, adapted to store the acoustic noise data and the operating conditions data. The processor is adapted to apply a transfer function to said acoustic noise data to correlate said data with a set of acoustic noise data measured at a remote location from the wind turbine. The system may comprise a controller adapted to generate a control signal, for outputting to a wind turbine controller, for adjusting the operating parameters of the wind turbine in dependence on said correlated data.

Also known in the prior art is Lutz Kerber et al., U.S. Pat. No. 8,041,540, issued on Oct. 18, 2011 (also published as US 20110135442 A1 on Jun. 9, 2011 and as European Patent Application Publication No. EP2333329 A2 on Jun. 15, 2011), which is said to disclose a method for monitoring a wind turbine. A monitoring signal, including an audio signal and/or an image signal, is received from a monitoring device. Operating data are calculated based on the received monitoring signal. An operating condition and/or a deviation is determined by comparing the operating data to baseline data.

Currently, there is a lack of available appliances that can accurately identify both acoustic and shadow-flicker events that may be associated with wind turbines. Thus, there is no unbiased, credible arbiter that can be relied on to accurately assess and respond to an actual event; this lack of comprehensive monitoring may lead to unnecessary anxiety on the part of abutters and others living in proximity to wind turbine projects.

There is a need for improved systems and methods for dealing with acoustic and shadow-flicker events.

### SUMMARY OF THE INVENTION

The prior art documents recognize either shadow-flicker or acoustic emissions from wind turbines. Many of these inventions operate solely at the wind turbine. We describe an entirely new invention that unifies both the shadow-flicker and acoustic detection and recognition technologies in a single appliance. In addition the comprehensive system acts as the “eyes and ears” at a monitored location. These integrative design characteristics create uniquely improved operational synergies and neighbor satisfaction.

This system architecture is based on years of experience by the inventors, addressing the difficult engineering challenges associated with siting and operating wind turbines in relatively close proximity to homes and other structures. A successful system preferably will address both technical and human factors. Accordingly, this invention is intentionally neighbor-centric.

As used in the present application, the term “neighbor-centric” is intended to denote a system that provides a comprehensive single-interface set of technologies that satisfy all of the acoustic or flicker concerns of a neighbor to a wind turbine as its priority. The purpose of the integral design is to address neighbors' concerns. As used in the present application, the term “human factors” is intended to denote the physical, perceptual and psychological behaviors of human beings who are neighbors of wind turbines. These factors play a major role in siting, permitting, legal, medical, and policy decisions with respect to wind turbines. The present invention addresses these factors by identifying and mitigating potential nuisances before neighbors are affected.

The integrated wind turbine noise and shadow-flicker detection and mitigation system can report its operational status, a flicker-mitigation status, and a noise-mitigation status to a user. As employed in this application, the term “user” includes either or both of a neighbor and a turbine operator.

A desired goal is to assure that potential sound and shadow issues are addressed for a monitored location with the greatest possible accuracy, confidence and transparency. Monitors installed at the customer location perform the identification of actual conditions, rather than predicted conditions based on models, and provide excellent levels of trust and user-satisfaction.

Siting of this system at the monitored location eases anxiety at that location with respect to possible nuisance events, regardless of whether nuisance events do actually occur; this addresses a major barrier to wind turbine siting near residences.

The base-unit (also referred to as a “base station”) is designed to be installed new, or as a “bolt-on” retrofit. Installation processes and communications protocols are very similar in each case. Regarding retrofit applications, the base-unit may be installed as an aftermarket device where turbine operators wish to provide post-hoc mitigation capabilities to address emergent neighbor concerns.

The invention comprises a set of interactive devices, including monitors and base-units. Monitors are located at each location where wind turbine noise or shadow-flicker is to be mitigated. Base-units are located at each wind turbine. Monitors continuously sense sound and light levels at each location where wind turbine noise or shadow-flicker is to be mitigated. When established criteria for wind turbine noise or shadow-flicker are exceeded, these monitors communicate with base-units in local wind turbines to initiate corrective action.

The most accurate location for observing sound levels and light levels for the purpose of mitigation is at the mitigated site. Sounds observed from wind turbines have diverse spectral characteristics that can be modified over distance based on wind direction, wind speed, atmospheric effects, and operating mode of the turbine. Acoustic emissions from wind turbines are modulated on a continuous basis by changes in atmospheric stability, snow on the ground, and by the seasonal presence of leaves on trees, for example. Light levels are also changed on their way to a wind turbine by leaves on trees as well.

By monitoring acoustic emissions and light levels on-location, the system provides a comprehensive safeguard at that location from potential wind-turbine nuisances. Being local, each monitor provides objective information on current conditions, system status, and mitigation activities; these design features collectively satisfy many of the psychological and human-factors needs that are not adequately addressed with current turbine-based or noise-only/flicker-only solutions.

The operation of the monitors and base-units is tightly interactive, with the computers in each device working collaboratively to more accurately recognize shadow-flicker and noise events, and to guard against situations that could otherwise be created by individuals to “spoof” sensing systems into triggering “false-positive” events.

The interaction between the monitor and the base-unit involves the relaying of a series of acoustic or light-level “signatures” from the monitor to the base-unit. The base unit compares the signatures received from the monitor to signatures that are collected at the wind turbine by the base-unit in order to make a decision as to the severity of possible wind turbine noise and shadow-flicker. The form of the signatures can be a sequence of “power spectral density” files that are unique to only one transmitter of light or sound emissions.

According to one aspect, the invention features an integrated wind turbine noise and shadow-flicker detection and mitigation system. The system comprises at least one monitoring device having an acoustic sensor configured to sense wind turbine noise, having an illumination sensor configured to sense shadow-flicker, and having a communication port configured to communicate using a communication protocol, with the at least one monitoring device situated at a location where wind turbine noise or shadow-flicker is to be mitigated; at least one base-unit located at a wind turbine to be controlled to mitigate wind turbine noise and shadow-flicker at the location where wind turbine noise or shadow-flicker is to be mitigated, the at least one base-unit having a wind turbine system control and data acquisition system, and having a communication port configured to communicate using a communication protocol; and a first data processor configured to process data from the at least one monitoring device and a second data processor configured to process data from the at least one base-unit, the first data processor and the second data processor configured to determine when either of a wind turbine noise condition or a shadow-flicker condition has reached a level at which mitigation is appropriate, and configured to issue commands to the at least one base-unit to control the wind turbine to be controlled so as to mitigate the wind turbine noise condition or a shadow-flicker condition at the location where wind turbine noise or shadow-flicker is to be mitigated.

In one embodiment, the acoustic sensor is a microphone.

In another embodiment, the wind turbine system control and data acquisition system comprises a local acoustic sensor.

In yet another embodiment, the wind turbine system control and data acquisition system comprises a local light sensor.

In still another embodiment, the first data processor and the second data processor are the same data processor.

According to another aspect, the invention relates to an integrated wind turbine noise and shadow-flicker detection and mitigation method. The method comprises the steps of: sensing acoustic and optical signals at a location where wind turbine noise or shadow-flicker is to be mitigated, and generating at least one electrical signal representative of the sensed acoustic and optical signals; communicating the at least one electrical signal to a data processor; analyzing the at least one electrical signal to determine a result that describes whether either of a wind turbine noise and a shadow-flicker at the location requires mitigation; in the event that either of the wind turbine noise and shadow-flicker does require mitigation, applying a correction signal to a wind turbine to mitigate the wind turbine noise and shadow-flicker that does require mitigation; performing at least one of recording the result, transmitting the result to a data handling system, or to displaying the result to a user; and iteratively repeating the above steps until a command to cease wind turbine operation is received.

In a further embodiment, the sensing is performed using at least one monitoring device having an acoustic sensor configured to sense wind turbine noise, having an illumination sensor configured to sense shadow-flicker, and having a communication port configured to communicate using a communication protocol, the at least one monitoring device situated at a location where wind turbine noise or shadow-flicker is to be mitigated.

In yet a further embodiment, the communicating is performed using a communications protocol selected from the group of communication protocols consisting of the Internet, a ModBus, a relay contactor, or a cell network.

In an additional embodiment, the result is generated using a digital signal-processing algorithm.

In one more embodiment, the digital signal-processing algorithm produces an acoustic or light-level signature based on the sensing step.

In still a further embodiment, the method further comprises the step of sensing a second acoustic signal at the wind turbine.

In one embodiment, the second acoustic signal sensed at the wind turbine is used to produce a second acoustic signature.

In another embodiment, the second acoustic signature of the wind turbine is derived from both current and past acoustic signals generated by the wind turbine.

In yet another embodiment, the digital signal-processing algorithm compares the first acoustic signature and the second acoustic signature.

In still another embodiment, the analyzing step uses data selected from a wind speed, a wind direction, an azimuthal position of the wind turbine, and the rotational speed of the wind turbine.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1A is a schematic diagram of communication between a single monitor and a wind turbine according to principles of the invention.

FIG. 1B is a schematic diagram of communication between multiple monitors and multiple wind turbines according to principles of the invention.

FIG. 2A is an image of a monitor device according to principles of the invention.

FIG. 2B is an image of a monitor device deployed in the field with a solar panel which provides power to the monitor.

FIG. 3 is a diagram showing an embodiment of a base-unit according to principles of the invention.

FIG. 4 is a flow diagram for a shadow-flicker data processing algorithm according to principles of the invention.

FIG. 5 is a flow diagram for an acoustic data processing algorithm according to principles of the invention.

### DETAILED DESCRIPTION

### The Problem

Around the world, utility-scale wind turbines are being installed where they can be seen and heard by those nearby. Occasionally, meteorological and operational conditions can create sound levels that exceed local noise criteria or cause stress to nearby residents. Also, certain times of the year it is possible for the sun to be in position to create a flickering shadow on a building such as a residence; this “shadow-flicker” can also be a source of stress to nearby residents.

Currently, residents living near (or persons who work near) wind turbines cannot signal the wind turbine to reduce noise or shadow-flicker. Instead, the affected people can only resort to telephoning the operator to make a complaint, or rely on the turbine operator to estimate noise or shadow-flicker levels at the nearby location. This is not a rigorous or timely process, and is unsatisfactory from both the affected person's and the operator's perspective.

Individuals who live or work near wind turbines do not have an appliance that can provide continuous and transparent detection and mitigation of wind turbine noise and shadow-flicker. Scientific instruments exist that are able to measure sound-levels or predict shadow-flicker, but are not designed to provide continuous monitoring and feedback to local residents. The current situation is frustrating to both individuals who are resident or who work in proximity to wind turbines and to wind turbine operators. As used herein, the term “neighbor” is used to denote a person who lives or who works in a location that is proximate to one or more wind turbines, e.g., the person and the wind turbine(s) are neighbors.

### The Solution

The systems and methods described, which are referred to as the “Sentinel: system, involve an intentionally neighbor-centric technology that addresses sound and shadow flicker at the location of the affected person with the greatest possible confidence and transparency. Due to atmospheric effects, only monitoring systems installed at an individual's home or work location can address sound level issues with highest confidence at that location. Being at the neighbor's location, monitors provide additional benefits that greatly increase trust and satisfaction with the overall mitigation system.

The purpose of this invention is to provide an integrated, credible, and transparent technology that serves residents living near wind turbines mitigation against nuisance noise and shadow-flicker events.

This set of detection, analytic, and communications technologies provide a single platform for satisfactorily addressing wind turbine noise and shadow-flicker concerns for nearby residents. Computers at both the wind turbine and nearby residences jointly make mitigation decisions over radio and other communications platforms, thereby minimizing errors and providing status and feedback information through those computers to both the nearby resident and wind turbine operator.

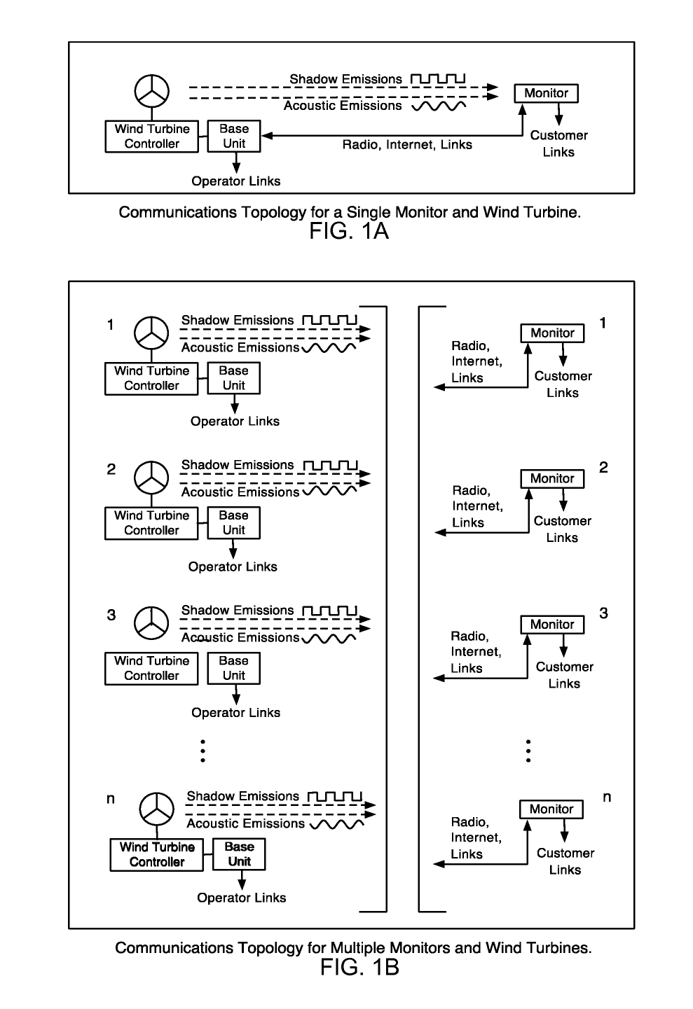

FIG. 1A is a schematic diagram of communication between a single monitor and a wind turbine according to principles of the invention.

FIG. 1B is a schematic diagram of communication between multiple monitors and multiple wind turbines according to principles of the invention.

FIG. 1A and FIG. 1B depict the communications topology for the integral system. Each monitor continually senses light and acoustic emissions from the wind turbine, employing signature-recognition methodologies to assess both the sound and light data. In the event of a possible nuisance, the monitor creates a signature of that event and relays it to the base-unit computer at the wind turbine. The base-unit computer compares its local signature to the signature arriving from the monitor, and applies other criteria to make the final determination of a nuisance event.

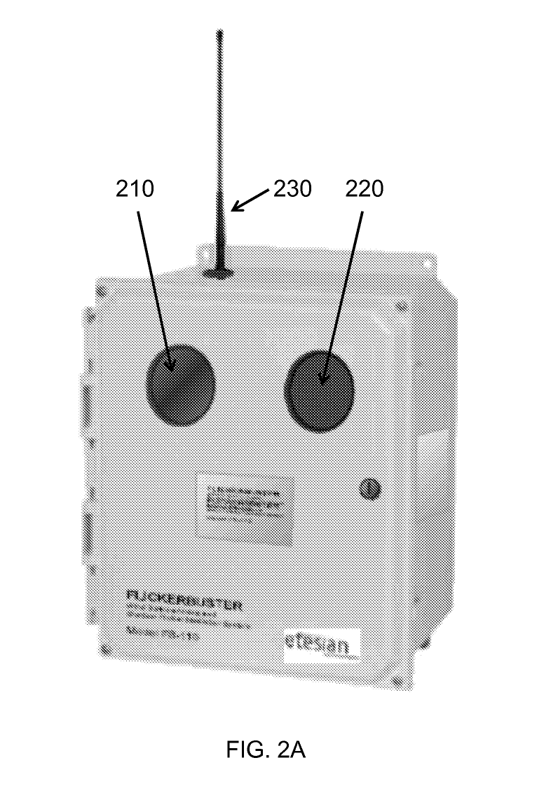

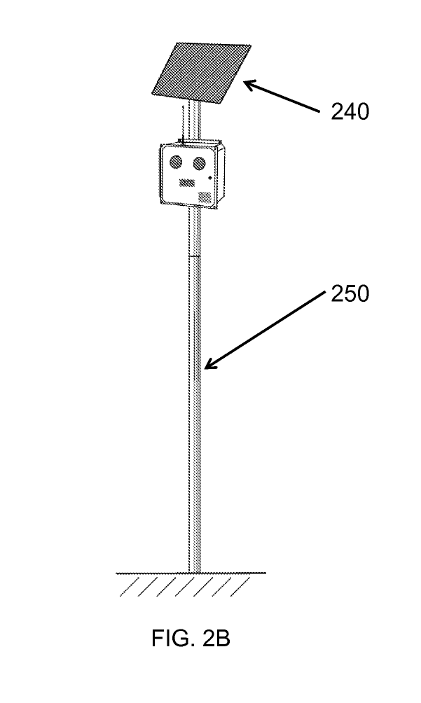

FIG. 2A is an image of a monitor device according to principles of the invention.

FIG. 2B is an image of a monitor device deployed in the field with a solar panel 240 which provides power to the monitor.

The monitor can be mounted on a separate tower or on a structure 250. The front of the monitor is pointed toward the wind turbine, and has an acoustic sensor 210 such as a microphone and a light-sensor or illumination sensor 220 installed on its face. A communication port 230 such as a radio link to the wind turbine and connectors for power and communications are also installed on the monitor. Status lights can be provided on the monitor to give local visual confirmation of operational readiness and event status. In some embodiments, the communication port 230 is bi-directional so that communications to and from the monitor can occur. For example, control signals or interrogation signals may be sent to the monitor, and data signals or responses to interrogations may be sent from the monitor.

In one embodiment, the monitor is enclosed in a NEMA level 4 environmental enclosure, with a windscreen, rain protection, and a bird spike. In some embodiments, the cabinet is provided with a lock. The monitor includes both an acoustic sensor and a light sensor.

In one embodiment, the acoustic sensor includes a calibrated, high-sensitivity outdoor-rated microphone, having a direction angle of 90 degrees. In some embodiments, the microphone meets IEC 61672 class I measurement specifications. In some embodiments, the microphone has a sensitivity of 40 mV/Pa. In some embodiments, the microphone has a frequency response of 20 Hz to 20 kHz. In some embodiments, the microphone has a dynamic range of 18 to 130 dB.

In one embodiment, the light sensor is a calibrated high-sensitivity outdoor-rated optical sensor, with a cover glass. In some embodiments, the light sensor has a sensitivity of 90 μA/KW/m². In some embodiments, the light sensor has a response time of 10 ms. In some embodiments, the light sensor has a stability with less than 2 percent variation per year.

In some embodiments, there is provided power supply using a low voltage mains or an optional 10 watt photovoltaic module.

In some embodiments, there is provided a data processor including a general purpose programmable computer having, memory, storage, and machine-readable instructions for conducting high-speed data processing for both acoustic and flicker monitoring, and managing communications with base-units and external clients. In a preferred embodiment, the data processor is located at the monitor. In other embodiments, the data processor is located remotely from the monitor. In some embodiments, the data processor is a shared data processor, such as a data processor accessed over the internet, such as a cloud processor.

In some embodiments, there are provided indicators, including a power-on indicator, an operating indicator, an acoustic event indicator, and a flicker event indicator.

Communications channels are provided including radio and Internet for each base-unit, and external communications via SMS and the Internet.

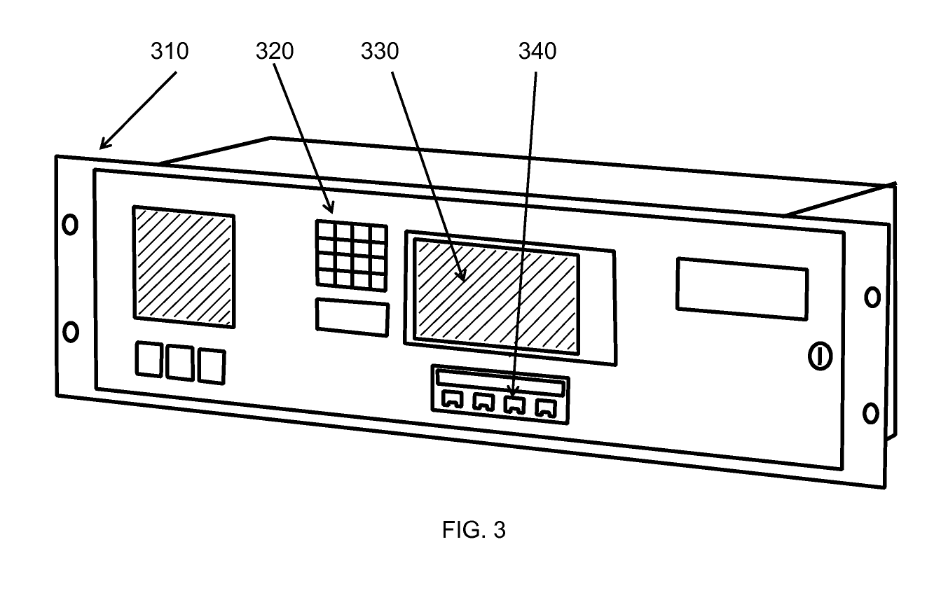

FIG. 3 is a diagram showing an embodiment of a base-unit according to principles of the invention. FIG. 3 depicts a rack-mount embodiment 310 of a base-unit device. It may be installed inside the wind turbine, attached to the turbine, or in a structure near the turbine. The base-unit is connected to a radio antenna, local sensors, power connections, the Internet, and the wind turbine system control and data acquisition system (SCADA) at the rack.

In some embodiments, the base-unit is provided in a standard 19-inch rack mount case, having 5.25 in. nominal height, with both front and back electrical and data port connections. In some embodiments, the power supply is 120 VAC. In some embodiments, there is provided a data processor including a general purpose programmable computer having memory, storage, and machine-readable instructions for conducting high-speed data processing for both acoustic and flicker monitoring, and for managing communications with monitors and external clients, as well as a display 330 for displaying the results of data processing to a user, recording those results, and transmitting the results and/or raw data to another system for further data processing. In a preferred embodiment, the data processor is located at the base-unit. In other embodiments, the data processor is located remotely from the base-unit. In some embodiments, the data processor is a shared data processor, such as a data processor accessed over the internet, such as a cloud processor.

In some embodiments, the same data processor serves both one or more monitors and one or more base-units.

In some embodiments, there are provided indicators 320, including a power-on indicator, an operating indicator, an acoustic event indicator, and a flicker event indicator.

Communication ports or channels 340 are provided including radio and Internet for each base-unit, and external communications via SMS and the Internet. In some embodiments, the communication port 340 is bi-directional so that communications to and from the base-unit can occur. For example, data, control signals or interrogation signals may be sent to the base-unit, and data signals or responses to interrogations may be sent from the base-unit to other devices.

In some embodiments, communications with a wind turbine are conducted using MODBUS or similar protocols, and relay contactors.

In one embodiment, there is provided for each wind turbine a local acoustic sensor that includes a calibrated, high-sensitivity outdoor-rated microphone, having a direction angle of 90 degrees. In some embodiments, the microphone meets IEC 61672 class I measurement specifications. In some embodiments, the microphone has a sensitivity of 40 mV/Pa. In some embodiments, the microphone has a frequency response of 20 Hz to 20 kHz. In some embodiments, the microphone has a dynamic range of 18 to 130 dB.

In one embodiment, there is provided for each base-unit a local light sensor that is a calibrated high-sensitivity outdoor-rated optical sensor, with a cover glass. In some embodiments, the light sensor has a sensitivity of 90 μA/KW/m². In some embodiments, the light sensor has a response time of 10 ms. In some embodiments, the light sensor has a stability with less than 2 percent variation per year.

In one embodiment, communication between the monitors and base-units relies on radio technologies using proprietary signal encoding. At long distances, larger antennas may be necessary. Internet connectivity between the monitors and base-units is an option.

At the wind turbine, the base-unit receives real-time wind turbine operating data through a link to the wind turbine System Control and Data Acquisition (SCADA) system The base-unit is designed to provide mitigation signals to the wind turbine controller via the SCADA, a simple relay, Modbus, or other standard communications protocol.

After receiving a mitigation signal, the turbine control system takes over the process to change its operating mode as appropriate for that machine, identified as a “mitigation event”. Interaction with wind turbine control systems is conducted in a manner that does not expose those systems to operational or security threats. Most current and legacy turbine models can be supported.

If a mitigation event is determined at the base-unit, the event and data are logged, and mitigation signals are transmitted to the wind turbine. Communication of mitigation events to individuals is performed via Internet, telephone, status lights, and cell networks.

In the Northern Hemisphere, monitors are located at the southern end of monitored buildings situated west of the wind turbines, and at the northern end for buildings situated east of the wind turbines, where shadow-flicker would first appear, thereby detecting and mitigating shadow-flicker before it can be seen by persons in the buildings. In the Southern Hemisphere, the opposite configuration is used.

Being located outdoors at the each location where sound issues need to be assessed, the monitors are sensitive enough to sense turbine-generated acoustic emissions at levels generally below the levels recognizable by human occupants.

Microphones in the monitors listen for acoustic emissions beginning at sound levels below those that would normally trigger a mitigation event. The decibel set-point level that triggers a mitigation event can be adjusted using a secure configuration process. This set point and other configurations can be inspected via software interface at both the monitor and base-unit. This adjustability is important due to the variation in the criteria for sound levels and sound characteristics that may be set by state and local regulators.

Physical tampering is prevented at both the monitor and base-unit. At the base-unit, access to the rack-mounted unit is key-locked. Physical tampering of the monitors is also prevented through use of weather-resistant steel locking cabinets and local power supplies. For Internet-connected systems, power loss at either the monitor or base-unit is included as an event that triggers a communication event.

Electronically, all configuration access to both each receiver and monitor is conducted through a username and password-protected interface.

“Spoofing” is defined as the deliberate manipulation of light or sound observed by the monitoring system for the purpose of causing a false sound- or flicker-based mitigation event to occur. Spoofing can be a potentially serious concern with monitoring systems deployed at neighbor locations. The interactive decision-making between the monitor and base-units can jointly distinguish between actual and false triggers through the application of a series of logical filters to incoming data, reducing the likelihood of successful spoofing to a very low level.

In a preferred embodiment, the process for monitoring wind turbine noise and/or shadow-flicker can be started automatically when both a monitor and base-station are turned on. In some embodiments, a command to start the monitoring process can be issued by a user of the system. The process can be iteratively repeated until a command to cease operation of the monitoring system is received.

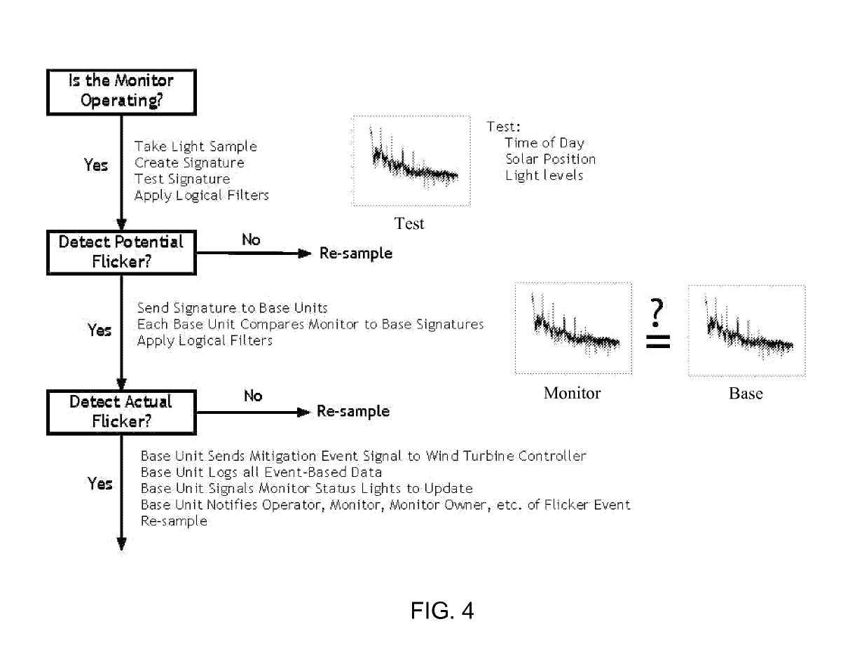

FIG. 4 is a flow diagram for a shadow-flicker data processing algorithm according to principles of the invention. FIG. 4 depicts the signal processing flow for detecting shadow flicker. At the monitor, flicker-based spoofing is prevented via application of criteria for ambient light levels; light variability filters that inspect the relative intensity and consistent periodicity of the light signal, compared those that could actually be produced by the wind turbine; and other filters as upgrades. At the base-unit, spoofing is filtered via real-time criteria based on turbine rotational speed, azimuthal position; wind speed, direction, operating mode; time-based filters that do not permit triggers except during the time of day; and seasonal filters that determine the days of the year that flicker events are possible; and other filters as upgrades.

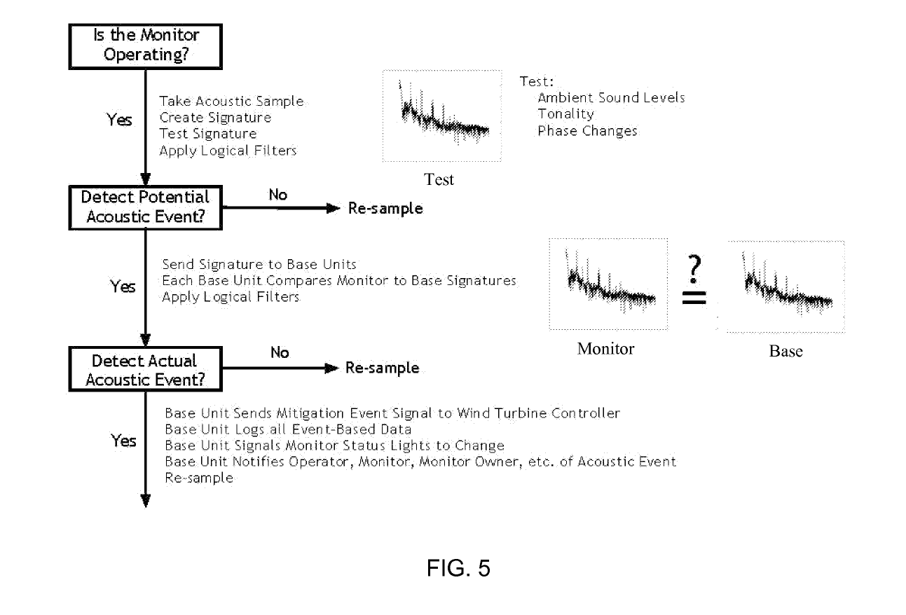

FIG. 5 is a flow diagram for an acoustic data processing algorithm according to principles of the invention. FIG. 5 depicts the signal processing flow for detecting acoustic events. At the monitor, acoustic-based spoofing is prevented via comparison of sound levels and acoustic patterns to past emissions recorded by the monitor at the site; and other logical filters as design upgrades. At the base-unit, acoustical spoofing is filtered via application of criteria based on turbine rotational speed, azimuthal position; wind speed, direction, and operating mode; acoustic signatures from other local monitors; and other filters as design upgrades.

Weather does not prevent the system from operating. With flicker, weather controls the intensity of light (and shadow) reaching the sensor. It is possible that the weather itself can mitigate shadow on a cloudy day, which the system automatically recognizes. Acoustically, weather and seasonal differences in snow- and leaf-cover can alter background and turbine-generated sound levels. Again, monitors are designed to distinguish between turbine sound and background sounds regardless of weather conditions.

For installations of multiple wind turbines and multiple monitors, any monitor can signal an event to a group of turbines and any turbine can respond to a single from any monitor. For shadow-flicker, the base-unit in a particular wind turbine can determine if that turbine is the source of the shadow through the use of solar timing, the light-signature time-series, and other data at that turbine. For acoustic events where there are multiple turbines, the wind turbine closest to the monitor sending the trigger is the first to respond to a mitigation signal. If the acoustic signature is not thereby sufficiently altered, the next closest wind turbine responds, and so on. In the event of a pure-tone event, the turbine emitting the pure-tone will be identified via the acoustic signature observed by the base-unit at that particular wind turbine.

Particular neighbors may choose to measure or mitigate either only noise or only shadow-flicker. The system is designed to provide one or the other single set of mitigation services as selected by the neighbor.

### DEFINITIONS

Any reference in the claims to an electronic signal or an electromagnetic signal (or their equivalents) is to be understood that in a preferred embodiment the signal is a non-transitory electronic signal or a non-transitory electromagnetic signal. If the signal per se is not claimed, the reference may in some instances be to a description of a propagating or transitory electronic signal or electromagnetic signal.

Recording the results from an operation or data acquisition, such as for example, recording results at a particular frequency or wavelength, is understood to mean and is defined herein as writing output data in a non-transitory manner to a storage element, to a machine-readable storage medium, or to a storage device. Non-transitory machine-readable storage media that can be used in the invention include electronic, magnetic and/or optical storage media, such as magnetic floppy disks and hard disks; a DVD drive, a CD drive that in some embodiments can employ DVD disks, any of CD-ROM disks (i.e., read-only optical storage disks), CD-R disks (i.e., write-once, read-many optical storage disks), and CD-RW disks (i.e., rewriteable optical storage disks); and electronic storage media, such as RAM, ROM, EPROM, Compact Flash cards, PCMCIA cards, or alternatively SD or SDIO memory; and the electronic components (e.g., floppy disk drive, DVD drive, CD/CD-R/CD-RW drive, or Compact Flash/PCMCIA/SD adapter) that accommodate and read from and/or write to the storage media. Unless otherwise explicitly recited, any reference herein to “record” or “recording” is understood to refer to a non-transitory record or a non-transitory recording.

As is known to those of skill in the machine-readable storage media arts, new media and formats for data storage are continually being devised, and any convenient, commercially available storage medium and corresponding read/write device that may become available in the future is likely to be appropriate for use, especially if it provides any of a greater storage capacity, a higher access speed, a smaller size, and a lower cost per bit of stored information. Well known older machine-readable media are also available for use under certain conditions, such as punched paper tape or cards, magnetic recording on tape or wire, optical or magnetic reading of printed characters (e.g., OCR and magnetically encoded symbols) and machine-readable symbols such as one and two dimensional bar codes. Recording image data for later use (e.g., writing an image to memory or to digital memory) can be performed to enable the use of the recorded information as output, as data for display to a user, or as data to be made available for later use. Such digital memory elements or chips can be standalone memory devices, or can be incorporated within a device of interest. “Writing output data” or “writing an image to memory” is defined herein as including writing transformed data to registers within a microcomputer.

“Microcomputer” is defined herein as synonymous with microprocessor, microcontroller, and digital signal processor (“DSP”). It is understood that memory used by the microcomputer, including for example instructions for data processing coded as “firmware” can reside in memory physically inside of a microcomputer chip or in memory external to the microcomputer or in a combination of internal and external memory. Similarly, analog signals can be digitized by a standalone analog to digital converter (“ADC”) or one or more ADCs or multiplexed ADC channels can reside within a microcomputer package. It is also understood that field programmable array (“FPGA”) chips or application specific integrated circuits (“ASIC”) chips can perform microcomputer functions, either in hardware logic, software emulation of a microcomputer, or by a combination of the two. Apparatus having any of the inventive features described herein can operate entirely on one microcomputer or can include more than one microcomputer.

General purpose programmable computers useful for controlling instrumentation, recording signals and analyzing signals or data according to the present description can be any of a personal computer (PC), a microprocessor based computer, a portable computer, or other type of processing device. The general purpose programmable computer typically comprises a central processing unit, a storage or memory unit that can record and read information and programs using machine-readable storage media, a communication terminal such as a wired communication device or a wireless communication device, an output device such as a display terminal, and an input device such as a keyboard. The display terminal can be a touch screen display, in which case it can function as both a display device and an input device. Different and/or additional input devices can be present such as a pointing device, such as a mouse or a joystick, and different or additional output devices can be present such as an enunciator, for example a speaker, a second display, or a printer. The computer can run any one of a variety of operating systems, such as for example, any one of several versions of Windows, or of MacOS, or of UNIX, or of Linux. Computational results obtained in the operation of the general purpose computer can be stored for later use, and/or can be displayed to a user. At the very least, each microprocessor-based general purpose computer has registers that store the results of each computational step within the microprocessor, which results are then commonly stored in cache memory for later use, so that the result can be displayed, recorded to a non-volatile memory, or used in further data processing or analysis.

Many functions of electrical and electronic apparatus can be implemented in hardware (for example, hard-wired logic), in software (for example, logic encoded in a program operating on a general purpose processor), and in firmware (for example, logic encoded in a non-volatile memory that is invoked for operation on a processor as required). The present invention contemplates the substitution of one implementation of hardware, firmware and software for another implementation of the equivalent functionality using a different one of hardware, firmware and software. To the extent that an implementation can be represented mathematically by a transfer function, that is, a specified response is generated at an output terminal for a specific excitation applied to an input terminal of a “black box” exhibiting the transfer function, any implementation of the transfer function, including any combination of hardware, firmware and software implementations of portions or segments of the transfer function, is contemplated herein, so long as at least some of the implementation is performed in hardware.

### Theoretical Discussion

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

Any patent, patent application, patent application publication, journal article, book, published paper, or other publicly available material identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. An integrated wind turbine noise and shadow-flicker detection and mitigation system, comprising:
at least one monitoring device having an acoustic sensor configured to sense wind turbine noise, having an illumination sensor configured to sense shadow-flicker, and having a communication port configured to communicate using a communication protocol, said at least one monitoring device situated at a location where wind turbine noise or shadow-flicker is to be mitigated;
at least one base-unit located at a wind turbine to be controlled to mitigate wind turbine noise and shadow-flicker at said location where wind turbine noise or shadow-flicker is to be mitigated, said at least one base-unit having a wind turbine system control and data acquisition system, and having a communication port configured to communicate using a communication protocol; and
a first data processor configured to process data from said at least one monitoring device and a second data processor configured to process data from said at least one base-unit, said first data processor and said second data processor configured to determine when either of a wind turbine noise condition or a shadow-flicker condition has reached a level at which mitigation is appropriate, and configured to issue commands to said at least one base-unit to control said wind turbine to be controlled so as to mitigate said wind turbine noise condition or a shadow-flicker condition at said location where wind turbine noise or shadow-flicker is to be mitigated.

2. The integrated wind turbine noise and shadow-flicker detection and mitigation system of claim 1, wherein said acoustic sensor is a microphone.

3. The integrated wind turbine noise and shadow-flicker detection and mitigation system of claim 1, wherein said wind turbine system control and data acquisition system comprises a local acoustic sensor.

4. The integrated wind turbine noise and shadow-flicker detection and mitigation system of claim 1, wherein said wind turbine system control and data acquisition system comprises a local light sensor.

5. The integrated wind turbine noise and shadow-flicker detection and mitigation system of claim 1, wherein said first data processor and said second data processor are the same data processor.

6. An integrated wind turbine noise and shadow-flicker detection and mitigation method, comprising the steps of:
sensing acoustic and optical signals at a location where wind turbine noise or shadow-flicker is to be mitigated, and generating at least one electrical signal representative of said sensed acoustic and optical signals;
communicating said at least one electrical signal to a data processor;
analyzing said at least one electrical signal to determine a result that describes whether either of a wind turbine noise and a shadow-flicker at said location requires mitigation;
in the event that either of said wind turbine noise and shadow-flicker does require mitigation, applying a correction signal to a wind turbine to mitigate said wind turbine noise and shadow-flicker that does require mitigation;
performing at least one of recording of said result, transmitting said result to a data handling system, or to displaying said result to a user; and
iteratively repeating the above steps until a command to cease operation is received.

7. The integrated wind turbine noise and shadow-flicker detection and mitigation method of claim 6, wherein said sensing is performed using at least one monitoring device having an acoustic sensor configured to sense wind turbine noise, having an illumination sensor configured to sense shadow-flicker, and having a communication port configured to communicate using a communication protocol, said at least one monitoring device situated at a location where wind turbine noise or shadow-flicker is to be mitigated.

8. The integrated wind turbine noise and shadow-flicker detection and mitigation method of claim 6, wherein said communicating is performed using a communications protocol selected from the group of communication protocols consisting of the Internet, a ModBus, a relay contactor, and a cell network.

9. The integrated wind turbine noise and shadow-flicker detection and mitigation method of claim 6, wherein said result is generated using a digital signal-processing algorithm.

10. The integrated wind turbine noise and shadow-flicker detection and mitigation method of claim 9, wherein said digital signal-processing algorithm produces an acoustic or light-level signature based on said sensing step.

11. The integrated wind turbine noise and shadow-flicker detection and mitigation method of claim 6, further comprising the step of sensing a second acoustic signal at said wind turbine.

12. The integrated wind turbine noise and shadow-flicker detection and mitigation method of claim 11, wherein said second acoustic signal sensed at said wind turbine is used to produce a second acoustic signature.

13. The integrated wind turbine noise and shadow-flicker detection and mitigation method of claim 11, wherein said second acoustic signature of said wind turbine is derived from both current and past acoustic signals generated by said wind turbine.

14. The integrated wind turbine noise and shadow-flicker detection and mitigation method of claim 12, wherein said digital signal-processing algorithm compares said first acoustic signature and said second acoustic signature.

15. The integrated wind turbine noise and shadow-flicker detection and mitigation method of claim 6, wherein said analyzing step uses data selected from a wind speed, a wind direction, an azimuthal position of said wind turbine, and the rotational speed of said wind turbine.
